(19) United States
(12) Patent Application Publication
(10) Pub. No.: US 2013/0037970 A1
(43) Pub. Date: Feb. 14, 2013

(54) OXYGEN HUMIDIFICATION BOTTLE

(71) Applicant: TAO-TSUN HSIUNG, TAIPEI CITY (TW)

(72) Inventor: TAO-TSUN HSIUNG, TAIPEI CITY (TW)

(73) Assignee: BESMED HEALTH BUSINESS CORP., NEW TAIPEI CITY (TW)

(21) Appl. No.: 13/208,562

(22) Filed: Aug. 12, 2011

(51) Int. Cl. B01F 3/04; F24F 3/14

(52) U.S. Cl. 261/64.1; 261/121.1

(57) ABSTRACT

An oxygen humidification bottle includes a bottle body, a cap, a duct and a plug. The cap includes an inlet pipe, an outlet pipe and a safety valve, and the duct is coupled to an end of the inlet pipe. When use, the bottle body contains water to a water level H, and dry oxygen is inputted from the inlet pipe into the bottle body, and a bent portion is formed at a section of the duct inside the bottle body and includes a plurality of first holes having a diameter Y, and equidistantly formed with a predetermined interval X apart from one another, and the dry oxygen in the water forms a plurality of air bubbles with a volume expansion rate Z, and the maximum volume is Y*Z*H, and X>Y*Z*H, so that the air bubbles are not in contact with one another to reduce the noise.

### BACKGROUND OF THE INVENTION

1. Field of the Invention

The present invention generally relates to medical equipments, in particular to an oxygen humidification bottle structure capable of reducing the collision of air bubbles to achieve the effect of reducing noises.

2. Description of the Related Art

In general, a breathing apparatus is usually used for treating patients having breathing difficulties and assisting them to breath compulsorily and providing them with a steady and appropriate supply of oxygen. The breathing apparatus is applied to medical treatments that require inhalations of oxygen. Since this type of breathing apparatus uses a mixed gas of oxygen and air and the mixed gas is a dry and low-temperature gas, therefore the patient's respiratory tract may feel uncomfortable after a long time of use. To minimize the effect of this phenomenon, the breathing apparatus is generally equipped with a humidification bottle that contains distilled water, and the mixed gas is inputted into the humidification bottle, such that the mixed gas can be mixed with the distilled water to obtain a filtered and appropriately humidified mixed gas.

With reference to FIG. 1 for a schematic view of a conventional humidification bottle, the humidification bottle 1 comprises a bottle body 11, a cap 12 and a duct 13, wherein the bottle body 11 is a container with an opening, and the opening has a first thread portion (not shown in the figure) formed at the exterior the opening, and the cap 12 has a second thread portion (not shown in the figure) for screwing and securing the cap 12 onto the opening of the bottle body 11, and the cap 12 further includes an inlet pipe 121 and an outlet pipe 122, and the duct 13 is connected to an end of the inlet pipe 121 and disposed in the bottle body 11. The bottle body 11 contains a distilled water 2, and after the mixed gas is inputted from the inlet pipe 121 into the bottle body 11, the mixed gas is guided by the duct 13 to enter into the distilled water 2 from the mouth of the inlet pipe 121, and many air bubbles 21 are produced in the distilled water 2. The volume of the air bubbles 21 in the distilled water 2 is expanded continuously to break the surface of the water, so as to achieve the effect of increasing the humidity of the mixed gas.

However, the air bubbles in water will be collided with one another and combined into larger air bubbles which will produce a larger sound when the water surface breaks. Such large sound is a nuisance that disturbs people's sleep or even affects a patient's recuperation. Therefore, various noise reduction structures are introduced in the market and applied to the humidification bottle, wherein another end of the duct is connected to a shunt plate or a shunt pipe installed in the bottle body, so that the mixed gas is shunted uniformly into the water, and thus the produced air bubbles will not be collided with one another to form larger air bubbles, so as to reduce the noise produced when the surface of water breaks. However, the shunt plate or pipe requires additional molding design, and medical equipments must be replaced after a certain time of use, and thus increasing the manufacturing and using costs.

In view of the aforementioned drawbacks, the inventor of the present invention provides an oxygen humidification bottle with a simple structure and a low manufacturing cost, and the oxygen humidification bottle comprises a duct and a plug, wherein the duct includes a plurality of openings having a specific design of the diameter and predetermined interval to assure that the plurality of air bubbles passing into the water will not be collided and combined with one another easily, so as to achieve the effect of reducing noises. In addition, it only needs to replace the duct for maintenance, and thus lowering the using and manufacturing costs significantly.

### SUMMARY OF THE INVENTION

Therefore, it is a primary objective of the present invention to provide an oxygen humidification bottle with a simple structure and a low manufacturing cost, and the design of the diameter and predetermined interval of a plurality of first holes of a duct is provided for reducing the chance of air bubbles colliding and combining with one another to achieve the effect of reducing noises.

To achieve the foregoing objective, the present invention provides an oxygen humidification bottle, for containing water, humidifying dry oxygen, and sending out the humidified oxygen. The oxygen humidification bottle comprises: a bottle body having an opening and a bottle base and containing water to a water level H; a cap covered onto the opening of the bottle body and having an inlet pipe, an outlet pipe and a safety valve installed at the top of the cap and interconnected to the interior of the bottle body, wherein the inlet pipe and outlet pipe are installed on both sides of the safety valve respectively, and the dry oxygen is inputted from the inlet pipe; a duct, having an end installed at the inlet pipe and disposed inside the bottle body, wherein a section of the duct is blocked by the bottle base to form a bent portion, and the bent portion has a plurality of first holes equidistantly formed with a predetermined interval X apart from one another, and each of the first holes has a diameter Y; and a plug fixed to an end of the duct having the bent portion and comprised of a plug base and a plug cover, wherein a distal portion of the plug base is coupled to the duct, and the other distal portion of the plug base has a plurality of claw hooks for latching the plug cover, and the plug cover has at least one second hole for inputting the dry oxygen, and the dry oxygen is blocked by the plug and sent from the first holes and the second hole into water to form a plurality of air bubbles with a volume expansion rate Z and obtain a maximum volume of the air bubbles equal to Y*Z*H, and the predetermined interval X of the first holes is greater than Y*Z*H.

Wherein, the plurality of air bubbles with a volume expansion rate Z formed by inputting the dry oxygen in water has a maximum volume equal to Y*Z*H, and X>Y*Z*H, so that the air bubbles moving in the water will not be contacted or combined with one another, and the volume of the air bubbles will not be increased, so as to achieve the effect of reducing noises.

Another objective of the present invention is to provide an oxygen humidification bottle structure, wherein of an inlet pipe installed at a cap includes a control ring for adjusting the input quantity of dry oxygen quickly to enhance the convenience of the operation significantly.

A further objective of the present invention is to provide an oxygen humidification bottle, wherein a safety valve installed at a cap includes a weight and an external cover, and the weight is wrapped and installed in the external cover, so that when the pressure exceeds a predetermined value, air is released to achieve the effect of adjusting the pressure inside the oxygen humidification bottle.

### BRIEF DESCRIPTION OF THE DRAWINGS

FIG. 1 is a schematic view of a conventional humidification bottle;

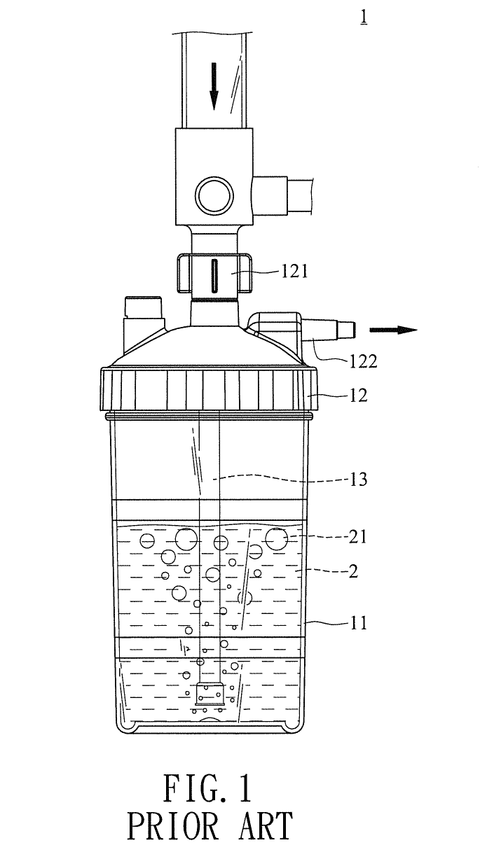

FIG. 2 is an exploded view of a humidification bottle in accordance with a preferred embodiment of the present invention;

FIG. 3 is a perspective view of a humidification bottle in accordance with the preferred embodiment of the present invention;

FIG. 4 is a schematic view of using a humidification bottle in accordance with the preferred embodiment of the present invention;

FIG. 5 is an exploded view of a plug in accordance with the preferred embodiment of the present invention; and

FIG. 6 is a schematic view of combining a plug in accordance with the preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

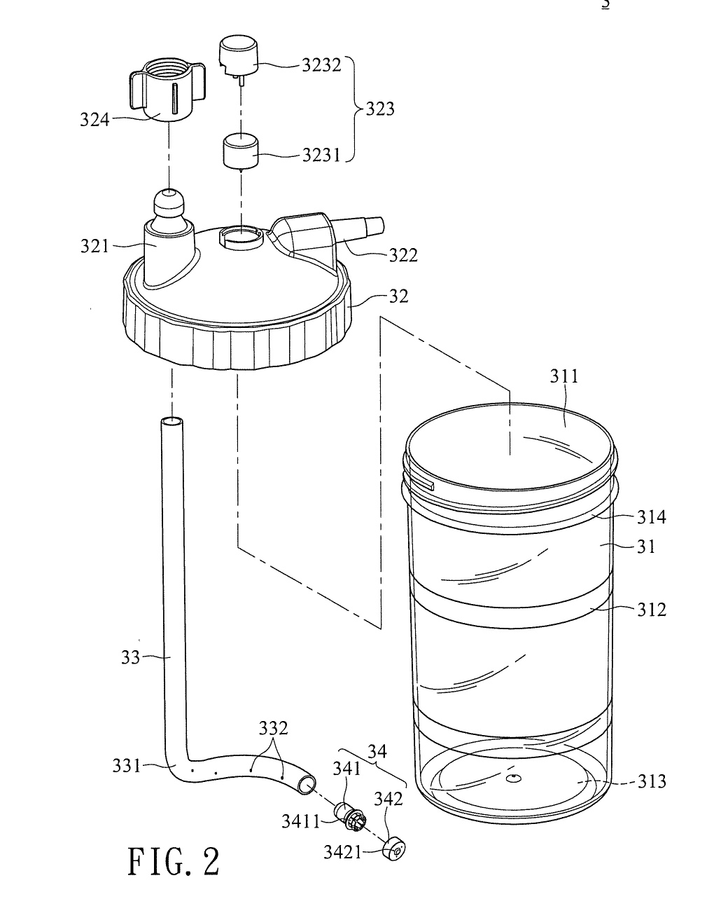

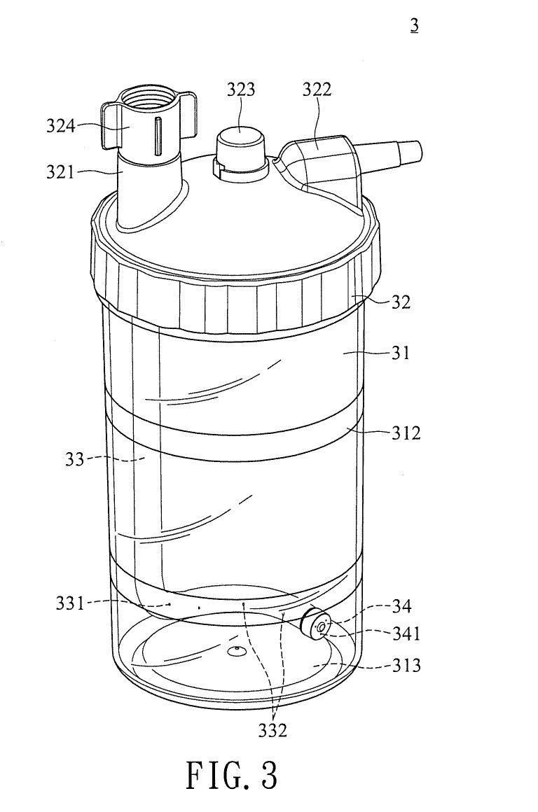

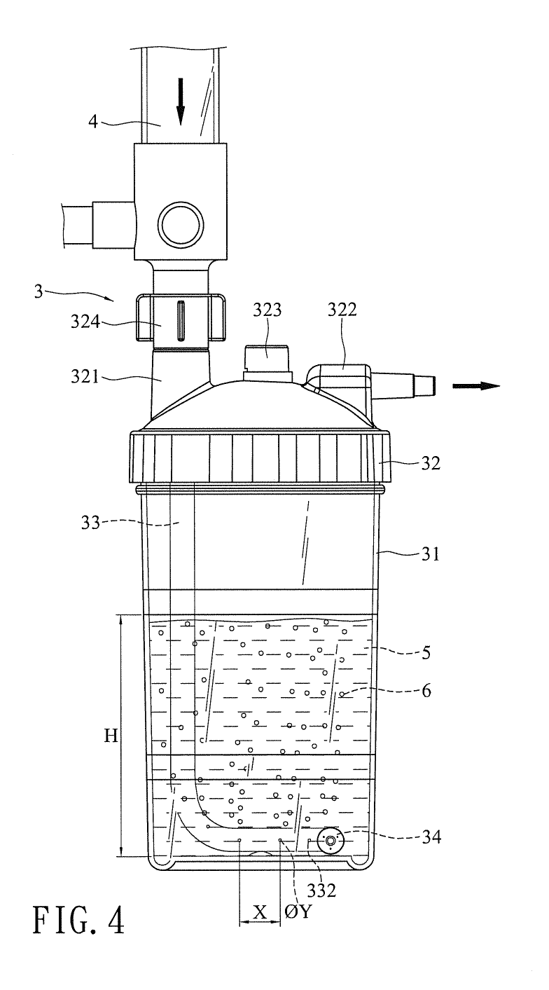

With reference to FIGS. 2 to 5 for an exploded view, a perspective view, and a schematic view of an application of an oxygen humidification bottle and schematic views of a plug in accordance with the preferred embodiment of the present invention respectively, the oxygen humidification bottle 3 comprises a bottle body 31, a cap 32, a duct 33 and a plug 34.

Wherein, the bottle body 31 is a container made of a transparent non-toxic plastic material, the bottle body 31 includes an opening 311, a water level indicator 312 and a bottle base 313, wherein a first thread portion 314 is disposed at the exterior of the opening 311, and the bottle body 31 contains water to a water level H which is the distance from the bottle base 313 to the water level indicator 312.

The cap 32 is covered onto the first thread portion 314 of the bottle body 31 for sealing the opening 311, and the cap 32 includes an inlet pipe 321, an outlet pipe 322 and a safety valve 323 installed at the top of the cap 32, and the inlet pipe 321, the outlet pipe 322 and the safety valve 323 are interconnected to the interior of the bottle body 31, wherein the inlet pipe 321 and the outlet pipe 322 are installed on both sides of the safety valve 323 respectively, and the dry oxygen 4 is inputted from the inlet pipe 321, and the safety valve 323 includes a weight 3231 and an external cover 3232, and the weight 3231 is wrapped inside the external cover 3232. If the gas pressure inside the bottle body 31 is greater than the weight of the weight 3231, the weight 3231 will be pushed to open, so as to achieve the pressure release effect. In addition, the inlet pipe 321 includes a control ring 324 for adjusting the input quantity of the dry oxygen 4 quickly.

The duct 33 is a tubular structure made of a soft material and has an end connected to the inlet pipe 321 and disposed in the bottle body 31, and a section at the other end of the duct 33 is blocked by the bottle base 313 to form a bent portion 331, and the bent portion 331 includes a plurality of first holes 332 formed equidistantly with a predetermined interval X apart from one another, and each of the first holes 332 has a diameter Y.

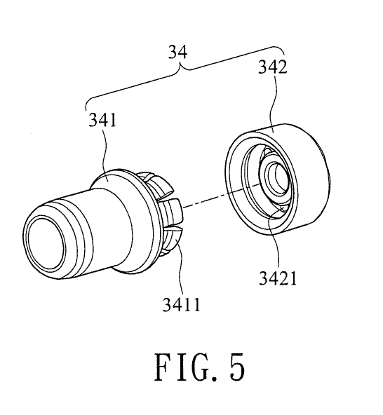

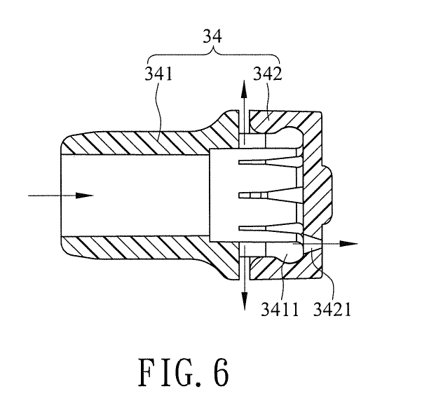

In FIGS. 5 and 6, the plug 34 is comprised of a plug base 341 and a plug cover 342, and a distal portion of the plug base 34 is fixed to the duct 33, and the bent portion 331 is disposed at an end, and the other distal portion of the plug base 34 has a plurality of claw hooks 3411 for latching the plug cover 342, and a plurality of venting channels (not shown in the figure) formed between the claw hooks 3411, and the plug cover 342 includes three second holes 3421 formed thereon, so that when the oxygen humidification bottle of the present invention is used, the dry oxygen is inputted from the second hole 3421 and the venting channels into the water to perform the oxygen humidification process.

When use, the oxygen humidification bottle of the present invention is provided for containing sterilized water 5, and the dry oxygen 4 is inputted from the inlet pipe 321 and guided by the duct 33 into the sterilized water 5 and the blocked by the plug 34, so that the dry oxygen 4 can be delivered from the first holes 332 into the water 5 to form a plurality of air bubbles 6 with a volume expansion rate Z in the water 5, and the maximum volume of the air bubbles 6 moving in the water 5 is equal to Y*Z*H, and X>Y*Z*H. Therefore, the air bubbles 6 moving in the water 5 will not be contacted and combined with one another, and the volume of the air bubbles 6 will not be increased too large, so as to achieve the effect of reducing noises.

In summation, the oxygen humidification bottle 3 of the present invention has a simple structure and a low manufacturing cost, and the special design of the diameter and predetermined interval of the first holes 332 of the duct 33 and the second holes 3421 of the plug 34 can reduce the chance of the air bubbles 6 colliding and combining with one another, so as to reduce the production of noises to achieve the effect of reducing noises. In addition, the inlet pipe 321 installed at the top of the cap 32 further includes the control ring 324 for adjusting the input quantity of the dry oxygen quickly to enhance the convenience of operating the oxygen humidification bottle.

Obviously, the invention improves over the prior art and complies with the patent application requirements, and thus is duly filed for patent application.

While the invention has been described by means of specific embodiments, numerous modifications and variations including the shape, size or material of the bottle body, the cap, the duct or the plug, or the manufacturing method of the first holes and the second hole could be made thereto by those skilled in the art without departing from the scope and spirit of the invention set forth in the claims.

What is claimed is:

1. An oxygen humidification bottle, for containing water, humidifying dry oxygen, and sending out the humidified oxygen, comprising:
a bottle body, having an opening and a bottle base, and containing water to a water level H;
a cap, covered onto the opening of the bottle body, and having an inlet pipe, an outlet pipe and a safety valve installed at the top of the cap and interconnected to the interior of the bottle body, and the inlet pipe and outlet pipe being installed on both sides of the safety valve respectively, and the dry oxygen being inputted from the inlet pipe;
a duct, having an end installed at the inlet pipe and disposed inside the bottle body, and a section of the duct being blocked by the bottle base to form a bent portion, and the bent portion having a plurality of first holes equidistantly formed with a predetermined interval X from one another, and each of the first holes having a diameter Y; and
a plug, fixed to an end of the duct, having the bent portion, and comprised of a plug base and a plug cover, and a distal portion of the plug base being coupled to the duct, and the other distal portion of the plug base having a plurality of claw hooks for latching the plug cover, and the plug cover having at least one second hole for outputting the dry oxygen, and the dry oxygen being blocked by the plug and sent from the first holes and the second hole into water to form a plurality of air bubbles with a volume expansion rate Z and obtain a maximum volume of the air bubbles equal to Y*Z*H, and the predetermined interval X of the first holes being greater than Y*Z*H.

2. The oxygen humidification bottle of claim 1, wherein the inlet pipe further includes a control ring for adjusting the input quantity of oxygen.

3. The oxygen humidification bottle of claim 1, wherein the safety valve includes a weight and an external cover, and the weight is wrapped and installed in the cap.
